(19) United States
(12) Patent Application Publication
(10) Pub. No.: US 2026/0065904 A1
(43) Pub. Date: Mar. 5, 2026

(54) OPEN EVALUATION AND BENCHMARKING FOR MACHINE LEARNING MODELS

(71) Applicant: QUALCOMM Incorporated, San Diego, CA (US)

(72) Inventors: Arvind Krishna SRIDHAR, San Diego, CA (US); Yinyi GUO, San Diego, CA (US); Erik VISSER, San Diego, CA (US)

(21) Appl. No.: 18/935,355

(22) Filed: Nov. 1, 2024

Related U.S. Application Data
(60) Provisional application No. 63/689,591, filed on Aug. 30, 2024.

(51) Int. Cl. G10L 15/183; G10L 15/01; G10L 15/02; G10L 15/04; G10L 15/22

(52) U.S. Cl. CPC G10L 15/183; G10L 15/01; G10L 15/02; G10L 15/04; G10L 15/22

(57) ABSTRACT

Disclosed are systems, apparatuses, processes, and computer-readable media for processing one or more images. For example, an apparatus comprising one or more processors and configured to: receive a natural language response from a first machine-learning model; segment the natural language response into a set of phrases; classify each phrase in the set of phrases based on at least one corresponding phrase in at least one ground truth response; remove a first subset of phrases from the set of phrases based on respective classifications of the first subset of phrases, wherein the first subset of phrases are not verified in the at least one ground truth response; and compute a metric associated with the first machine-learning model based on respective classifications of a second subset of phrases from the set of phrases, wherein the second subset of phrases are verified in the at least one ground truth response.

### CROSS-REFERENCE TO RELATED APPLICATIONS

This application claims priority to U.S. Provisional Patent Application No. 63/689,591, filed Aug. 30, 2024, which is hereby incorporated by reference, in its entirety and for all purposes.

### TECHNICAL FIELD

The disclosure relates generally to machine learning models. For example, aspects of the present disclosure include systems and techniques for providing open evaluation and benchmarking for machine learning models (e.g., generative machine learning models).

### BACKGROUND

A multimodal generative machine learning (ML) system generates natural language responses from natural language inputs and can incorporate various forms of data, such as audio and text. For instance, such an ML system can include an encoder that processes audio features (such as spectral, temporal, and pitch features) and a projection engine that converts the features into text. A generative ML system can use the text features to generate relevant responses in natural language form.

A generative ML system can perform a wide range of tasks such as answering questions, providing explanations, generating creative content, assisting with coding, and offering recommendations. Various tools may be connected to the generative ML system to allow interaction with external systems, such as browsing the Internet, generating images, executing code, etc., Generative ML systems are designed to assist users in solving problems, learning new information, and enhancing productivity.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for open evaluation and benchmarking techniques for generative machine learning models. According to aspects described herein, methods are disclosed for providing objective measurements of generative machine learning (ML) models and system. According to at least one example, an apparatus is provided that includes one or more memories (e.g., configured to store audio data, the audio data including a sequence of audio frames) and one or more processors (e.g., implemented in circuitry) coupled to the one or more memories and configured to: receive a natural language response from a first machine-learning model, wherein the natural language response is responsive to a first natural language query; segment the natural language response into a set of phrases; classify each phrase in the set of phrases based on at least one corresponding phrase in at least one ground truth response; remove a first subset of phrases from the set of phrases based on respective classifications of the first subset of phrases, wherein the first subset of phrases are not verified in the at least one ground truth response; and compute a metric associated with the first machine-learning model based on respective classifications of a second subset of phrases from the set of phrases, wherein the second subset of phrases are verified in the at least one ground truth response.

In another example, a method is provided. The method includes: receiving a natural language response from a first machine-learning model, wherein the natural language response is responsive to a first natural language query; segmenting the natural language response into a set of phrases; classifying each phrase in the set of phrases based on at least one corresponding phrase in at least one ground truth response; removing a first subset of phrases from the set of phrases based on respective classifications of the first subset of phrases, wherein the first subset of phrases are not verified in the at least one ground truth response; and computing a metric associated with the first machine-learning model based on respective classifications of a second subset of phrases from the set of phrases, wherein the second subset of phrases are verified in the at least one ground truth response.

In another example, a non-transitory computer-readable storage medium is provided comprising instructions stored thereon which, when executed by at least one processor, cause the at least one processor to: receive a natural language response from a first machine-learning model, wherein the natural language response is responsive to a first natural language query; segment the natural language response into a set of phrases; classify each phrase in the set of phrases based on at least one corresponding phrase in at least one ground truth response; remove a first subset of phrases from the set of phrases based on respective classifications of the first subset of phrases, wherein the first subset of phrases are not verified in the at least one ground truth response; and compute a metric associated with the first machine-learning model based on respective classifications of a second subset of phrases from the set of phrases, wherein the second subset of phrases are verified in the at least one ground truth response.

In another example, an apparatus is provided that includes: means for receiving a natural language response from a first machine-learning model, wherein the natural language response is responsive to a first natural language query; means for segmenting the natural language response into a set of phrases; means for classifying each phrase in the set of phrases based on at least one corresponding phrase in at least one ground truth response; means for removing a first subset of phrases from the set of phrases based on respective classifications of the first subset of phrases, wherein the first subset of phrases are not verified in the at least one ground truth response; and means for computing a metric associated with the first machine-learning model based on respective classifications of a second subset of phrases from the set of phrases, wherein the second subset of phrases are verified in the at least one ground truth response.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, each apparatus can include a camera or multiple cameras for capturing one or more images. In some aspects, each apparatus can include a display or multiple displays for displaying one or more images, notifications, and/or other displayable data. In some aspects, each apparatus can include one or more sensors (e.g., one or more inertial measurement units (IMUs), such as one or more gyroscopes, one or more gyrometers, one or more accelerometers, or any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating a machine learning (ML) system for generating natural language responses based on natural language input;

FIG. 2 is a conceptual block diagram of a system for benchmarking generative ML models and systems in accordance with some aspects of the disclosure;

FIG. 3 is a conceptual block diagram of a system for benchmarking generative ML models and systems in accordance with some aspects of the disclosure;

FIG. 4 is a flow diagram illustrating an example of a process for benchmarking generative ML models in accordance with some aspects of the disclosure;

FIG. 5 is a block diagram of an example transformer in accordance with some aspects of the disclosure; and

FIG. 6 shows an example of a computing system, which may be for example any computing device that may implement components of the system.

### DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Generative machine learning (ML) models can provide a conversational interface that uses natural language prompts as inputs, such as text or voice. For instance, a user can provide an input prompt in natural language to the generative ML model, and the generative ML model can provide a response in natural language form. The input prompt and the output response can optionally be combined with one or more other types of information or data, such as images or files. For example, the generative ML model can be requested to perform a particular function with an input image or write code based on structured data (e.g., extensible markup language (XML) or JavaScript object notations (JSON), etc.) within the file.

Generative ML models use different types of benchmarks to identify improvements. Examples of benchmarks include bilingual evaluation understudy (BLEU), metric for evaluation of translation with explicit ordering (METEOR), recall-oriented understudy for gisting evaluation (ROUGE), consensus-based image description evaluation (CIDER), sparsity promoting iterated constrained endmembers (SPICE), Spider, and bidirectional encoder representations from transformers (BERT). Benchmarks from these mechanisms typically use a procedural comparison of word representations in generated outputs. For example, procedural comparison techniques include objective text differential comparisons such as Levenshtein distance, which computes a pairwise character or word difference between a generated string and a validation string. Other types of comparison include Hamming distance, Jaccard similarity, Jaro-Winkler distance, and so forth.

In add

Benchmarking ML models based on conventional metrics described above can limited utility, particularly in tasks involving natural language generation. For example, existing large language models (LLMs) generate lengthy descriptive answers for a question and often include a significant amount of context from the user's question and other context identified during inference. Although the user can read the answer fully and understand the answer, there is no benchmark or test suite that can objectively measure the quality of generated answers. Other current machine learning models have plateaued on conventional benchmarks because these metrics fail to capture the complexities of human language and do not evaluate semantic, contextual, and pragmatic nuances of language and generated language. Even though significant progress has been made in ML models, the model performance using conventional benchmark techniques does not show these improvements because the benchmark techniques are not the evaluation metric that does not accurately reflect the quality, relevance, or creativity of the generated content. In addition, benchmarking and testing of existing measures in different modal domains (e.g., computer vision, speech-to-text synthesis tasks, optical flow, etc.) do not consider the length and order aspect of the answer.

Systems, apparatuses, processes (also referred to as methods), and computer-readable media (collectively referred to as “systems and techniques”) are described herein for open evaluation and benchmarking techniques for generative machine learning models. For example, an apparatus is configured to receive a natural language response from a first machine-learning model, segment the natural language response into a set of phrases, classify each phrase in the set of phrases based on at least one corresponding phrase in at least one ground truth response; and compute a metric associated with the first machine-learning model based on respective classifications of a second subset of phrases from the set of phrases. In some cases, the apparatus may remove a first subset of phrases from the set of phrases based on respective classifications of the first subset of phrases. The first subset of phrases is not verifiable in the at least one ground truth response.

In some aspects, an open evaluation metric is provided based on the application of ground truth information with respect to generated natural language responses. The metric provides a more accurate and objective representation of ML model performance.

Further aspects and examples related to the present disclosure are included in Appendix A attached hereto, the contents of which is hereby incorporated by reference in its entirety and for all purposes.

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

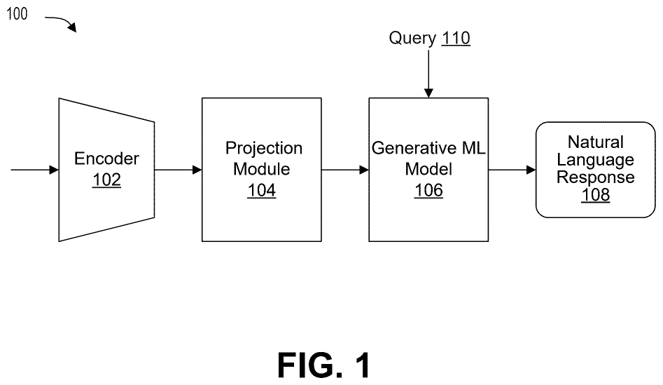

FIG. 1 is a block diagram illustrating a multimodal generative ML system 100 for generating natural language responses based on natural language input. A multimodal machine learning system is an ML model that receives, processes, and outputs data in multiple forms. For example, a large audio language model (LALM) combines encoding audio into a form suitable for a large language model (LLM) to provide an intermediate output (e.g., text) or final output (e.g., audio).

For example, the multimodal generative ML system 100 includes an encoder 102 that is configured to encode input audio into audio features. For example, the audio features can represent a portion of audio over a duration (also referred to as an audio frame) and its corresponding features in that duration. Non-limiting examples of features include spectral features (e.g., Short-Time Fourier Transform (STFT) coefficients, Mel-frequency cepstral coefficients (MFCCs), or Mel-spectrograms) that describe how energy is distributed across frequency, temporal features (e.g., zero-crossing rate and energy) and other time-domain properties, and pitch features that capture the perceived pitch. In some cases, the encoder 102 may identify features that might include formants that characterize resonant frequencies in speech, rhythmic features related to timing and tempo, and harmonic features that describe the relationship between fundamental frequencies and their harmonics.

The audio features from the encoder 102 are provided to a projection engine 104 that converts the modes of features. For example, the projection engine 104 converts audio features into text features based on one or more audio frames. The text features are output from the projection engine 104 and into a generative ML model 106 that is configured to generate a natural language response 108 based on the input information (e.g., text features from the projection engine 104) and a query 110. The generative ML model 106 is configured to use the text features extracted from the projection engine 104 and extract different types of features from the text that are relevant. For example, the text can be a query for a particular type of information. The generative ML model 106 is able to extract different tasks that are related to the query and then perform those tasks, such as writing code to perform a particular function.

The generative ML model 106 may include many different components, such as a featurization engine to identify different types of features, identify inferences within the text (e.g., pronoun usage and corresponding disambiguation functions), data retrieval engines (e.g., to identify features related to a particular concept observed by the generative ML model 106), and so forth. The generative ML model 106 may also include different types of models and engines to synthesize a coherent contextual output that synthesizes the input content and information that is responsive to tasks embedded within the text. For example, the generative ML model 106 may include a predictive output engine (not shown) that is configured to generate a sequence of words that is the most likely contextually correct and provide a coherent and contextually relevant answer. For example, the predictive output generation engine generates responses by sampling from the probability distribution of possible words and sequences based on patterns observed during training. The generative ML model 106 may also include a predictive output generation engine to generate multiple responses that are potentially relevant and coherent. The generative ML model 106 may also include an output validation engine configured to evaluate the generated responses based on certain criteria. Non-limiting examples of criteria to evaluate generated responses include relevance to the prompt, coherence, fluency, and adherence to specific guidelines or rules. Based on the evaluation, the output validation engine may select and output the most appropriate response.

The generative ML model 106 may include various types of ML models, such as a transformer. A transformer is a neural network architecture built into natural language processing (NLP) tasks, such as language translation, sentiment analysis, and text summarization. Conventional traditional recurrent neural networks (RNNs) process data in sequence, which slows the operations and training. A transformer or transformer network can process input in parallel and is faster and more efficient than sequential training and processing. In some aspects, transformers use a self-attention mechanism, which allows a transformer to identify the most relevant parts of the input text or content (e.g., audio or video). In some cases, transformers can also use a cross-attention mechanism which uses other content or data to determine the most relevant parts of the input. For example, cross-attention mechanisms are useful in sequential content such as a stream of data, such as optical flow, and other computer vision techniques.

A transformer model includes a multi-layer encoder-decoder architecture. The encoder takes the input text, converts the input text into a sequence of hidden representations and captures the meaning of the text at different levels of abstraction. The decoder then uses these representations to generate an output sequence, such as a text translation or a summary. The encoder and decoder are trained together using a combination of supervised and unsupervised learning techniques, such as maximum likelihood estimation and self-supervised pretraining. Illustrative examples of transformer engines include a BERT model, a Text-to-Text Transfer Transformer (T5), biomedical BERT (BioBERT), scientific BERT (SciBERT), and the SPECTER model for document-level representation learning. In some aspects, multiple transformer engines may be used to generate different embeddings.

An embedding is a representation of a discrete object, such as a word, a document, or an image, as a continuous vector in a multi-dimensional space. An embedding captures the semantic or structural relationships between the objects, such that similar objects are mapped to nearby vectors, and dissimilar objects are mapped to distant vectors. Embeddings are commonly used in machine learning, computer vision, and natural language processing tasks, such as language modeling, sentiment analysis, and machine translation. Embeddings are typically learned from large corpora of data using unsupervised learning algorithms, such as word2vec, GloVe, or fastText, which optimize the embeddings based on the co-occurrence or context of the objects in the data. Once learned, embeddings can be used to improve the performance of downstream tasks by providing a more meaningful and compact representation of the objects.

In some aspects, the generative ML model 106 may be executed using a neural engine for on-device execution. A neural engine that includes a plurality of neural processing cores that are configured to parallelize operations associated with neural networks. A neural processing core includes arrays of multiply-accumulate (MAC) units and specialized instructions that are optimized for matrix operations, such as convolution and matrix multiplication. A neural processing core receives input data and performs matrix transformations and nonlinear activation functions to break down and parallelize matrix operations. The neural processing core is configured to perform tasks such as inference (e.g., runtime operation of an ML model) or training of deep learning models and accelerates tasks by parallelization of larger computations that can be performed in parallel (e.g., matrix operations associated with neural networks). For example, a neural engine may perform computer vision tasks such as object recognition. In some cases, the neural engine can be implemented based on various ML libraries such as PyTorch, which interfaces with the compute unified device architecture (CUDA) to parallelize operations.

In one example, the generative ML model 106 may be a small generative model that has fewer parameters, fewer layers, fewer neurons, or a simpler architecture compared to larger models. A small generative model may not capture the full complexity of the underlying data distribution as effectively as larger models but can still be useful in scenarios where computational resources are limited or where a simpler model is sufficient for the task. Small generative models can also be easier to train and interpret, making them suitable for certain applications. For example, ChatGPT-3.5 has 175 billion parameters and would result in a size of 1.4 Terabytes (TB) for a model implemented with double-precision floating point numbers. A smaller model may have a simpler architecture, use fewer parameters (e.g., 10 million), and use less precise numbers (e.g., single-precision floating point numbers) resulting in a size of 38 Megabytes (MB).

In addition, small models benefit from increased training based on local execution and data specific to a local device and a user of that local device. An additional benefit to small models is increased privacy because the information is not transmitted over the network and only relies on information requested by the user or usage at the local device.

In some aspects, a LALM is configured for audio captioning and audio classification of the audio. Audio captioning includes describing the given audio in a natural language sentence (e.g., text) including verbal content and non-verbal content (e.g., environmental sounds). Audio classification refers to identifying the audio events that occur in the audio. Audio captioning and audio classification are both divided into three categories: audio labels, audio caption, and semantic evaluators. Audio label evaluators include mean average precision and f1 scores of different labels applied to the captions or classifications. Caption evaluators compare the words or phrase overlap between predicted captions. Audio label evaluators and caption evaluators neglect the order in which the substrings (e.g., audio events) appear in a sentence, which can be used in temporal reasoning. Semantic evaluators may utilize a transformer-based text encoder and evaluate the semantic similarity between two sentences in the text embedding space.

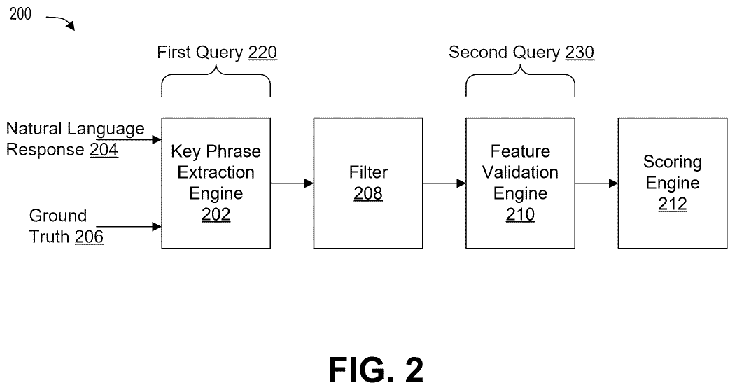

LALMs may generate a lengthy, descriptive, and complexly worded answers based on a query associated with input audio. The responses from the LALM may be with descriptive adjectives and intuitive explanation behind their answers. The lengthy responses may be problematic for testing and benchmarking of LALM responses based on the length of the response and the order aspect of the answer (e.g., the order of sentences considering the audio captions and audio labels). FIG. 2 is a conceptual block diagram of a system 200 for benchmarking generative ML models and systems in accordance with some aspects of the disclosure. In some aspects, the system 200 includes evaluation system that can provide an objective analysis of the natural language responses of an ML model.

In one aspect, the system 200 includes a key phrase extraction engine 202 that receives a natural language response 204 from a generative ML model (e.g., the generative ML model 106 in FIG. 1) or any other model configured to provide a natural language response (e.g., human-readable text). Non-limiting examples of a generative ML model include ChatGPT, Claude, LLAMA, Mistral, xgen, Falcon, and so forth. In some aspects, the natural language response 204 may be associated with multimodal input, such as a LALM. For example, aural information (e.g., speech) may be input into an automatic speech recognition (ASR) model to receive corresponding text output based on the aural information. Non-limiting examples of an ASR model include Whisper, Seamless, wav2vec2, and so forth. The text from the ASR model may be provided to the LLM to generate the natural language response 204 (e.g., the natural language response 108 in FIG. 1).

The key phrase extraction engine 202 may also receive a ground truth 206 related to the natural language response 204. For example, the ground truth 206 may be provided as part of a test suite that evaluates many iterations of the system 200 based on different types of input. In some cases, the ground truth 206 can be an explicit answer. The ground truth 206 may also be generated based on curated input provided into an ML (e.g., the generative ML model 106 in FIG. 1.) For example, the ground truth 206 may be an explicit link to an answer (e.g., a hypertext transfer protocol (HTTP) link, etc.). In this case, the ML model (e.g., the generative ML model 106 in FIG. 1) may retrieve the information in the link and generate a ground truth statement based only on information within that link.

In some aspects, the key phrase extraction engine 202 is configured to independently extract key phrases from the natural language response 204 and the ground truth 206. For example, the key phrase extraction engine 202 may be implemented with an LLM such as LLAMA-8B to extract independent phrases from sentences and other grammatical constructs within the natural language response 204 and the ground truth 206. For example, the key phrase extraction engine 202 may include an attention mechanism that can identify the key statements. In some cases, the key phrase extraction engine 202 may also be implemented with an NLP library such as natural language toolkit (NLTK), OpenNLP, spacy, etc. An attention mechanism can be incorporated from a tensor or other library to analyze the output tokens from the NLP to identify key phrases. Key phrases may be a majority of a complete sentence, but some grammatical constructs (e.g., determiners such as “a,” “an,” and “the”, etc.) are removed and other tokens are emphasized.

The key phrases from the natural language response 204 or the ground truth 206 may be provided to a filter 208. In some aspects, the filter 208 may be procedural rules but may also be part of an ML model. The filter 208 is configured to analyze the key phrases from the natural language response 204 and the ground truth 206 and remove key phrases from the natural language response 204 based on the detection of the presence of corresponding features within the ground truth 206. For example, the filter 208 may remove unverifiable features from the natural language response 204 that cannot be found within the ground truth 206. The key phrases may be vectorized features and the filter 208 may compute a similarity between aspects of the key phrases. In one example, the filter 208 may compute the cosine similarity of each key phrase in the natural language response 204 and the ground truth 206. A high cosine similarity indicates the features within the key phrases of the natural language response 204 and the ground truth 206 match and indicates that the information within the natural language response 204 can be verified with respect to the ground truth 206. Other types of similarity can be used to identify whether features in the natural language response 204 are present within the ground truth 206. Non-limiting examples include Sentence-BERT, and so forth.

The remaining key phrases from the natural language response 204 and all key phrases from the ground truth 206 are provided to a feature validation engine 210 to individually compare the phrases. In some aspects, the feature validation engine 210 is configured to identify relationships of each key phrase in the natural language response 204 with at least one key phrase in the ground truth 206. Based on these relationships, facts from each key phrase can be compared to identify the relationship of the key phrase. Key phrases can be classified into at least three categories including majority of matching features between the key phrases (e.g., a majority match), partial matching features between the key phrases (e.g., a partial match), and minimal to no overlapping features between the key phrases (e.g., a minority match). In this case, the unverifiable phrases were removed, and the feature validation engine 210 may classify into a majority match and a partial match. In some aspects, the majority match indicates a strong majority (e.g., approximately 90%) of features are identified, and the minority match indicates a strong minority (e.g., approximately 10%).

In some cases, the feature validation engine 210 may further classify the partial match based on the difference between features of the key phrase in the natural language response 204 and the key phrase in the ground truth 206. Three potential differences can be identified including features exclusive to the natural language response 204 (e.g., features not found in the ground truth 206), overlapping features in both the natural language response 204 and the ground truth 206, and features exclusive to the ground truth 206 (e.g., features not found in the natural language response 204).

For example, Table 1 illustrates an object that represents key features extracted by the key phrase extraction engine 202 from a natural language response 204 that is related to a multimodal input (e.g., audio), and the phrases are represented by three strings in an array. Table 2 illustrates an object that represents key features extracted by the key phrase extraction engine 202 from a ground truth 206 corresponding to the that is related to a multimodal input, and the phrases are represented by two strings in an array.

TABLE 1

```
{
  phrases: [
    “Following the beep, a male speech is heard. ”,
    “This indicates the audio has transitioned from an initial alert
      or notification to a more informative or conversational tone,
      ”,
    “possibly indicating the start of a podcast episode, a news
      report, or presentation”
  ]
}
```

TABLE 2

```
{
  phrases: [
    “After the beep, a male speech can be heard, ”,
    “indicating that a person is speaking in the audio.”
  ]
}
```

In Tables 1 and 2, the first phrases are both deemed a majority match because the semantic concepts are almost identical. The second phrases in Tables 1 and 2 are deemed a partial match because the concept at least partially overlaps. For example, the key phrase in Table 1 includes additional information indicating additional information (e.g., alert or notification, speech in a particular tone). The last phrase in Table 1 is deemed a minority match because the semantic concepts are not present in the ground truth 206.

The results of the feature validation engine 210 are provided to a scoring engine 212 that is configured to compute an objective evaluation of the generative ML model that generated the natural language response 204. In some aspects, unverifiable information (e.g., key phrases that are deemed a minority match) that is different between the natural language response 204 and the ground truth 206 is filtered and cannot be evaluated, and may therefore not directly impact the score. The number of key phrases from the natural language response 204 can be used to control the score generated by the scoring engine 212 (e.g., relative weighting). On the other hand, key phrases that are deemed majority match provide a strong indication and are directly used in the score calculation in the score engine 212. Partial matches may be evaluated based on the information within the natural language response 204 and whether the different features are in the ground truth 206. For example, if a partial match key phrase omits information within the natural language response 204, the partial match may adversely affect the scoring.

The score engine 212 evaluates each match, the frequency of the matches, and the number of unverifiable features to yield a final metric associated with the generative ML model that outputs the natural language response 204.

In some aspects, the key phrase extraction engine 202 may be implemented based on a first query 220 into a generative ML model to extract key phrases from the natural language response 204 and the ground truth 206. The generative ML model may be the same as the generative ML model or may be different. In some cases, an 8 billion parameter such as Meta-Llama-3.1-8B-Instruct can be used as the generative ML model to perform functionality based on the first query.

In some aspects, the feature validation engine 210 may be implemented based on a second query 230 into a generative ML model to extract key phrases from the natural language response 204 and the ground truth 206. The generative ML model may be the same as the generative ML model or may be different. In some cases, an 8 billion parameter such as Meta-Llama-3.1-8B-Instruct can be used as the generative ML model to perform functionality based on the second query.

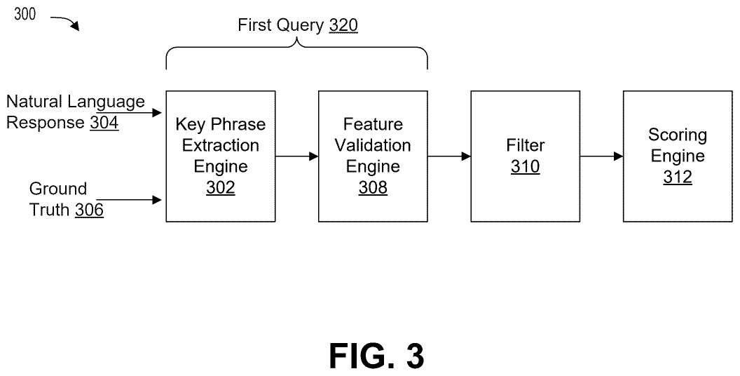

FIG. 3 is a conceptual block diagram of a system 300 for benchmarking generative ML models and systems in accordance with some aspects of the disclosure.

The system 300 includes a key phrase extraction engine 302 (e.g., the key phrase extraction engine 202 in FIG. 2) that receives a natural language response 304 from a generative ML model (e.g., the generative ML model 106 in FIG. 1) or any other model configured to provide a natural language response (e.g., human-readable text). The key phrase extraction engine 302 may also receive a ground truth 306 related to the natural language response 304. The key phrase extraction engine 302 is configured to independently extract key phrases from the natural language response 304 and the ground truth 306. For example, the key phrase extraction engine 302 may be implemented with an LLM such as LLAMA-8B to extract independent phrases from sentences and other grammatical constructs within the natural language response 304 and the ground truth 306.

In some cases, the key phrases may be provided to a feature validation engine 308 (e.g., the feature validation engine 210 in FIG. 2) to classify the different key phrases in the natural language response 304 and the ground truth 306. After the classification of the key phrases and identification of any phrase differences, the key phrases and corresponding data are provided to a filter 310, which removes unverifiable phrases. For example, key phrases from the natural language response 304 that are deemed minority matches may be discarded. Metadata related to the minority matches (e.g., the number of minority matches) may be preserved.

A score engine 312 (e.g., the score engine 212 in FIG. 2) may then score the generative ML model that generated the natural language response 304 based on the key phrase matches.

In some aspects, the key phrase extraction engine 302 and the feature validation engine 308 may be configured with a first query that includes sufficient instructions to identify the key features and validate the features. In this case, the features may remain in their multidimensional embedding space based on the query, which may improve the accuracy of the feature comparisons.

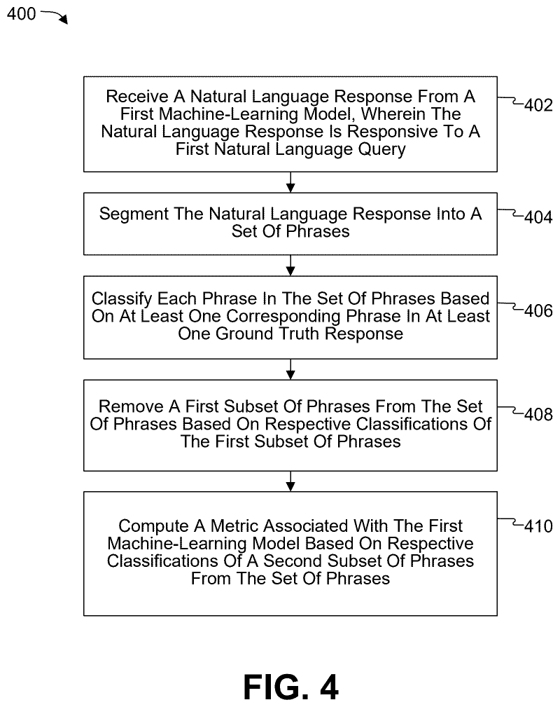

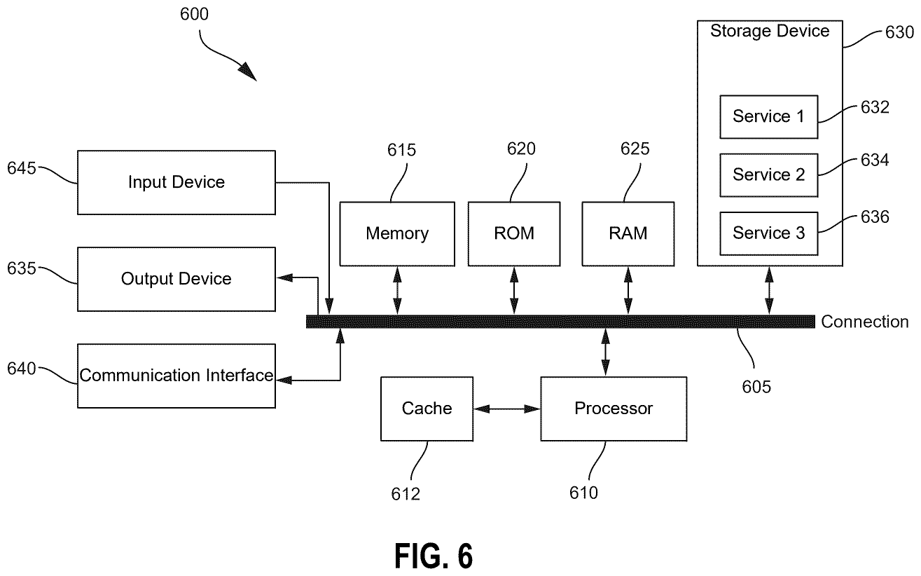

FIG. 4 is a flowchart illustrating an example process 400 for benchmarking generative ML models and systems in accordance with aspects of the present disclosure. The process 400 can be performed by a computing device (or apparatus) or a component (e.g., one or more chipsets, a system-on-chip (SoC), one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of the process 400 may be implemented as software components that are executed and run on one or more processors (e.g., CPU, GPU, DSP, NPU or neural engine, SoC, the processor 610 of FIG. 6, and/or other processor(s)).

At block 402, the computing device (or component thereof) may receive a natural language response from a first machine-learning model. For example, the natural language response may be responsive to a first natural language query. In one example, a LALM may receive an input of a multimodal content such as audio. A query into the LALM may inquire “how long does the male speech last before the pause?” In this case, the LALM may generate the response illustrated in Table 3. A ground truth may be provided as part of a testing library or benchmark function.

TABLE 3

| LALM Generated Response | Ground Truth |
|---|---|
| based on common audio formats, it is likely | The male speech lasts until |
| that the male speech lasts for several | the pause, which implies |
| seconds or minutes before the pause, which | that the pause is a brief |
| allows the listener to absorb and process | moment of silence, possibly |
| the content being presented. The pause then | a few seconds, before the |
| provides a brief moment of silence or | speaker continues speaking |
| background noise to allow the listener to | or another sound event |
| reflect on what has been said or prepare | occurs. |
| for the next segment. This structure is | |
| often used in podcasts, lectures, or other | |
| forms of spoken content to create a sense | |
| of flow and engagement with the audience. | |

At block 404, the computing device (or component thereof) may segment the natural language response into a set of phrases. In one aspect, to segment the natural language response, the computing device may provide a second query to a second machine-learning model including the at least one ground truth response. The second machine-learning model is different from the first machine-learning model. For example, the second machine-learning model may be based on LLAMA. In this aspect, the second machine-learning model may extract phrases from the LALM generated response and the ground truth and shown below in Table 4. For example, Table 4 identifies the features extracted from each text.

TABLE 4

| LALM Generated Response | | Ground Truth | |
|---|---|---|---|
| 1. | common audio formats | 1. | The male speech lasts until |
| 2. | the male speech lasts for several | | the pause |
| | seconds or minutes before the | 2. | the pause is a brief moment of |
| | pause | | silence |
| 3. | The pause then provides a brief | 3. | before the speaker continues |
| | moment of silence or | | speaking or another sound |
| | background noise | | event occurs. |
| 4. | allow the listener to reflect on | | |
| | what has been said or prepare | | |
| | for the next segment. | | |
| 5. | This structure is often used in | | |
| | podcasts, lectures, or other | | |
| | forms of spoken conten6. create | | |
| | a sense of flow and engagement | | |
| | with the audience | | |

At block 406, the computing device (or component thereof) may classify each phrase in the set of phrases based on at least one corresponding phrase in at least one ground truth response. In one example, the respective classifications include at least one of minimal overlapping features, majority overlapping features, or partial overlapping features. In one aspect, the computing device, to classify a first phrase in the set of phrases, may identify a corresponding phrase associated with the first phrase in the at least one ground truth response, determine a similarity between features of the corresponding phrase and features of the first phrase, and determine a classification for the first phrase based on the similarity. The computing device (or component thereof) may also determine an additional similarity between at least one of features of the corresponding phrase and not present in the first phrase or features of the first phrase and not in the corresponding phrase and determine the classification for the first phrase further based on the additional similarity.

At block 408, the computing device (or component thereof) may remove a first subset of phrases from the set of phrases based on respective classifications of the first subset of phrases. In this case, the first subset of phrases are not verified in the at least one ground truth response. For example, each phrase in the first subset of phrases corresponds to the minimal overlapping features.

In some aspects, the computing device (or component thereof) may generate a respective score for each phrase in the second subset of phrases based on a quantity of overlapping features between features in the second subset of phrases and the at least one ground truth response. Table 5 illustrates mapping the LALM generated response phrases to the phrases in the ground truth and resulting score from ClapScore, which is the cosine similarity of text embeddings in audio-text shared embedding space. In this case, a cosine similarity of 1.0 indicates identical and 0.0 having no similarity. In some cases, the scores for each phrase can be used to fine tune an ML model. For example, the respective score and the at least one corresponding phrase are provided to a reinforcement learning feedback loop, wherein the reinforcement learning feedback loop is configured to train the first machine-learning model. Each respective score and the at least one corresponding phrase are provided to a reinforcement learning feedback loop, wherein the reinforcement learning feedback loop is configured to train the first machine-learning model.

TABLE 5

| LALM Generated Response | Ground Truth | ClapScore |
|---|---|---|
| the male speech lasts for | The male speech lasts until | 0.537 |
| several seconds or minutes | the pause | |
| before the pause | | |
| The pause then provides a | the pause is a brief moment of | 0.185 |
| brief moment of silence or | silence | |
| background noise | | |
| brief moment of silence | brief moment of silence | 1.0 |
| allow the listener to reflect | before the speaker continues | 0.354 |
| on what has been said or | speaking or another sound | |
| prepare for the next segment | event occurs | |
| common audio formats | No matching phrase | 0.0 |
| create a sense of flow and | No matching phrase | 0.0 |
| engagement with the audience | | |

At block 410, the computing device (or component thereof) may compute a metric associated with the first machine-learning model based on respective classifications of a second subset of phrases from the set of phrases. In some aspects, the second subset of phrases are verified in the at least one ground truth response, and the metric is associated with a difference in information in the natural language response and the at least one ground truth response. For example, the metric represents an accuracy of the first machine-learning model.

In some cases, to segment the natural language response and classify each phrase, the computing device (or component thereof) may provide a second query to a second machine-learning model different from the first machine-learning model. In this case, the second machine-learning model is configured to segment the natural language response into phrases, segment the at least one ground truth response into ground truth phrases, and compare the phrases and the ground truth phrases based on the second query.

In some cases, the generative response engine can be local to the device and may be referred to as a small model. The small model is useful in cases of privacy, such as learning specific user details, or in the context of a limited role, such as a small model for a specific application. In some cases, the small model may interface with other built-in models of other applications.

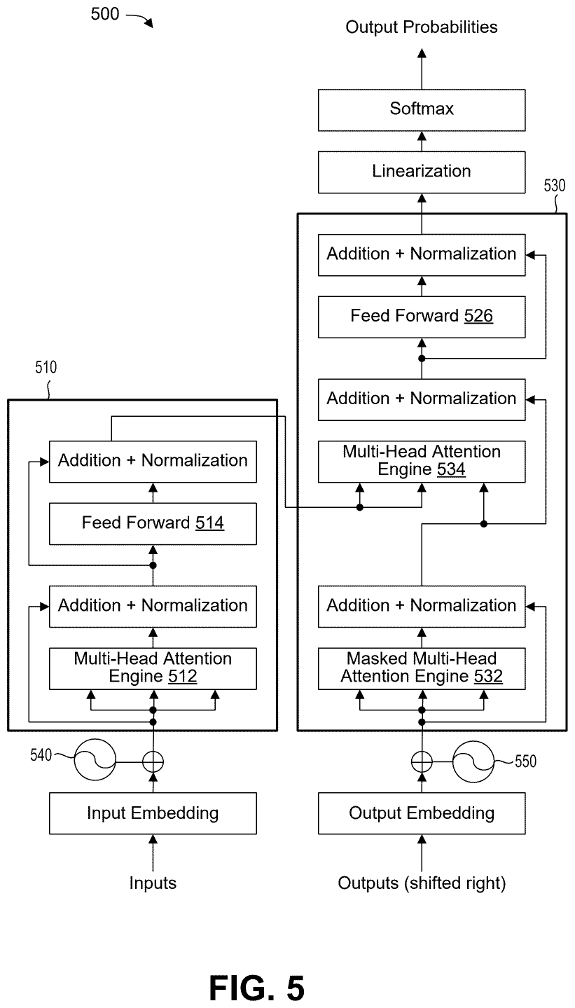

In some aspects, training of one or more of the machine learning systems or neural networks described herein (e.g., such as the multimodal generative ML system 100 of FIG. 1, the system 200 of FIG. 2, the system 300 of FIG. 3, the transformer block 500 of FIG. 5, among various other machine learning networks described herein) can be performed using online training (e.g., in some case on-device training), offline training, and/or various combinations of online and offline training. In some cases, online may refer to time periods during which the input data (e.g., such as the input 204 of FIG. 2, the input 304 of FIG. 3, etc.) is processed, for instance for performance of the open evaluation and benchmarking processing implemented by the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

FIG. 5 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. The transformer 500 reduces the operations of learning dependencies by using an encoder 510 and a decoder 530 that implements an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 510 is composed of a stack of six identical layers and each layer has two sub-layers. The first sub-layer is a multi-head self-attention engine 512, and the second sub-layer is a fully connected feed-forward network 514. A residual connection (not shown) connects around each of the sub-layers followed by normalization.

In this example of a transformer 500, the decoder 530 is also composed of a stack of six identical layers. The decoder also includes a masked multi-head self-attention engine 532, a multi-head attention engine 534 over the output of encoder 510, and a fully connected feed-forward network 526. Each layer includes a residual connection (not shown) around the layer, which is followed by layer normalization. The masked multi-head self-attention engine 532 is masked to prevent positions from attending to subsequent positions and ensures that the predictions at position i can depend only on the known outputs at positions less than i (e.g., auto-regression).

In the transformer 500, the queries, keys, and values are linearly projected by a multi-head attention engine into learned linear projects, and then attention is performed in parallel on each of the learned linear projects, which are concatenated and then projected into final values.

The transformer also includes a positional encoder 540 to encode positions because the model does not contain recurrence and convolution and relative or absolute position of the tokens is needed. For example, the positional encodings are added to the input embeddings at the bottom layer of the encoder 510 and the decoder 530. The positional encodings are summed with the embeddings because the positional encodings and embeddings have the same dimensions. A corresponding position decoder 550 is configured to decode the positions of the embeddings for the decoder 530.

In some aspects, the transformer 500 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 500 can process input sequences of variable length, making it well-suited for natural language processing tasks where input lengths can vary greatly. Additionally, the self-attention mechanism allows the transformer 500 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 6 is a diagram illustrating an example of a system for implementing certain aspects of the present technology. In particular, FIG. 6 illustrates an example of a computing system 600, which can be for example any computing device making up internal computing system, a remote computing system, a camera, or any component thereof in which the components of the system are in communication with each other using a connection 605. The connection 605 can be a physical connection using a bus, or a direct connection into the processor 610, such as in a chipset architecture. The connection 605 can also be a virtual connection, networked connection, or logical connection.

In some aspects, the computing system 600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

An example computing system 600 includes at least one processing unit (a central processing unit (CPU) or processor) 610 and a connection 605 that couples various system components including a system memory 615, such as ROM 620 and RAM 625 to the processor 610. The computing system 600 can include a cache 612 of high-speed memory connected directly with, in close proximity to, or integrated as part of the processor 610.

The processor 610 can include any general purpose processor and a hardware service or software service, such as services 632, 634, and 636 stored in the storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction, the computing system 600 includes an input device 645, which can represent any number of input mechanisms, such as a microphone for speech, a touch-sensitive screen for gesture or graphical input, keyboard, mouse, motion input, speech, etc. The computing system 600 can also include an output device 635, which can be one or more of a number of output mechanisms. In some instances, multimodal systems can enable a user to provide multiple types of input/output to communicate with the computing system 600. The computing system 600 can include communications interface 640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another IC chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 630 can include software services, servers, services, etc., that when the code that defines such software is executed by the processor 610, it causes the system to perform a function. In some aspects, a hardware service that performs a particular function can include the software component stored in a computer-readable medium in connection with the necessary hardware components, such as the processor 610, the connection 605, the output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the processes described herein (e.g., process 400, and/or other process described herein) may be performed by a computing device or apparatus. In one example, the method 800 can be performed by a computing device having a computing architecture of the computing system 600 shown in FIG. 6.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus comprising: one or more memories configured to store audio data, the audio data including a sequence of audio frames; and one or more processors coupled to the one or more memories and configured to: receive a natural language response from a first machine-learning model, wherein the natural language response is responsive to a first natural language query; segment the natural language response into a set of phrases; classify each phrase in the set of phrases based on at least one corresponding phrase in at least one ground truth response; remove a first subset of phrases from the set of phrases based on respective classifications of the first subset of phrases, wherein the first subset of phrases are not verified in the at least one ground truth response; and compute a metric associated with the first machine-learning model based on respective classifications of a second subset of phrases from the set of phrases, wherein the second subset of phrases are verified in the at least one ground truth response.

Aspect 2. The apparatus of Aspect 1, wherein the metric is associated with a difference in information in the natural language response and the at least one ground truth response.

Aspect 3. The apparatus of any of Aspects 1 or 2, wherein, to segment the natural language response, the one or more processors are configured to: provide a second query to a second machine-learning model including the at least one ground truth response, wherein the second machine-learning model is different from the first machine-learning model.

Aspect 4. The apparatus of any of Aspects 1 to 3, wherein, to classify a first phrase in the set of phrases, the one or more processors are configured to: identify a corresponding phrase associated with the first phrase in the at least one ground truth response; determine a similarity between features of the corresponding phrase and features of the first phrase; and determine a classification for the first phrase based on the similarity.

Aspect 5. The apparatus of Aspect 4, wherein the one or more processors are configured to: determine additional similarity between at least one of features of the corresponding phrase and not present in the first phrase or features of the first phrase and not in the corresponding phrase; and determine the classification for the first phrase further based on the additional similarity.

Aspect 6. The apparatus of any of Aspects 1 to 5, wherein the respective classifications include at least one of minimal overlapping features, majority overlapping features, or partial overlapping features.

Aspect 7. The apparatus of Aspect 6, wherein each phrase in the first subset of phrases corresponds to the minimal overlapping features.

Aspect 8. The apparatus of any of Aspects 6 or 7, wherein the one or more processors are configured to: generate a respective score for each phrase in the second subset of phrases based on a quantity of overlapping features between features in the second subset of phrases and the at least one ground truth response.

Aspect 9. The apparatus of Aspect 8, wherein each respective score and the at least one corresponding phrase are provided to a reinforcement learning feedback loop, wherein the reinforcement learning feedback loop is configured to train the first machine-learning model.

Aspect 10. The apparatus of any of Aspects 1 to 9, wherein the metric represents an accuracy of the first machine-learning model.

Aspect 11. The apparatus of any of Aspects 1 to 10, wherein, to segment the natural language response and classify each phrase, the one or more processors are configured to provide a second query to a second machine-learning model different from the first machine-learning model.

Aspect 12. The apparatus of Aspect 11, wherein the second machine-learning model is configured to segment the natural language response into phrases, segment the at least one ground truth response into ground truth phrases, and compare the phrases and the ground truth phrases based on the second query.

Aspect 13. The apparatus of any of Aspects 1 to 12, further comprising one or more microphones configured to capture the audio data.

Aspect 14. A method comprising: receiving a natural language response from a first machine-learning model, wherein the natural language response is responsive to a first natural language query; segment the natural language response into a set of phrases; classifying each phrase in the set of phrases based on at least one corresponding phrase in at least one ground truth response; removing a first subset of phrases from the set of phrases based on respective classifications of the first subset of phrases, wherein the first subset of phrases are not verified in the at least one ground truth response; and computing a metric associated with the first machine-learning model based on respective classifications of a second subset of phrases from the set of phrases, wherein the second subset of phrases are verified in the at least one ground truth response.

Aspect 15. The method of Aspect 14, wherein the metric is associated with a difference in information in the natural language response and the at least one ground truth response.

Aspect 16. The method of any of Aspects 14 or 15, wherein segmenting the natural language response comprises: providing a second query to a second machine-learning model including the at least one ground truth response, wherein the second machine-learning model is different from the first machine-learning model.

Aspect 17. The method of any of Aspects 14 to 16, further comprising classifying a first phrase in the set of phrases based on: identifying a corresponding phrase associated with the first phrase in the at least one ground truth response; determining a similarity between features of the corresponding phrase and features of the first phrase; and determining a classification for the first phrase based on the similarity.

Aspect 18. The method of Aspect 17, further comprising: determining additional similarity between at least one of features of the corresponding phrase and not present in the first phrase or features of the first phrase and not in the corresponding phrase; and determining the classification for the first phrase further based on the additional similarity.

Aspect 19. The method of any of Aspects 14 to 18, wherein the respective classifications include at least one of minimal overlapping features, majority overlapping features, or partial overlapping features.

Aspect 20. The method of Aspect 19, wherein each phrase in the first subset of phrases corresponds to the minimal overlapping features.

Aspect 21. The method of any of Aspects 19 or 20, further comprising: generating a respective score for each phrase in the second subset of phrases based on a quantity of overlapping features between features in the second subset of phrases and the at least one ground truth response.

Aspect 22. The method of Aspect 21, wherein each respective score and the at least one corresponding phrase are provided to a reinforcement learning feedback loop, and wherein the reinforcement learning feedback loop is configured to train the first machine-learning model.

Aspect 23. The method of any of Aspects 14 to 22, wherein the metric represents an accuracy of the first machine-learning model.

Aspect 24. The method of any of Aspects 14 to 23, wherein, segmenting the natural language response and classifying each phrase comprises providing a second query to a second machine-learning model different from the first machine-learning model.

Aspect 25. The method of Aspect 24, wherein the second machine-learning model is configured to segment the natural language response into phrases, segment the at least one ground truth response into ground truth phrases, and compare the phrases and the ground truth phrases based on the second query.

Aspect 26. A non-transitory computer-readable medium having stored thereon instructions that, when executed by at least one processor, cause the at least one processor to perform operations according to any of Aspects 14 to 25.

Aspect 27. An apparatus including one or more means for performing operations according to any of Aspects 14 to 25.

What is claimed is:

1. An apparatus comprising:
one or more memories configured to store audio data, the audio data including a sequence of audio frames; and
one or more processors coupled to the one or more memories and configured to:
receive a natural language response from a first machine-learning model, wherein the natural language response is responsive to a first natural language query;
segment the natural language response into a set of phrases;
classify each phrase in the set of phrases based on at least one corresponding phrase in at least one ground truth response;
remove a first subset of phrases from the set of phrases based on respective classifications of the first subset of phrases, wherein the first subset of phrases are not verified in the at least one ground truth response; and
compute a metric associated with the first machine-learning model based on respective classifications of a second subset of phrases from the set of phrases, wherein the second subset of phrases are verified in the at least one ground truth response.

2. The apparatus of claim 1, wherein the metric is associated with a difference in information in the natural language response and the at least one ground truth response.

3. The apparatus of claim 1, wherein, to segment the natural language response, the one or more processors are configured to:
provide a second query to a second machine-learning model including the at least one ground truth response, wherein the second machine-learning model is different from the first machine-learning model.

4. The apparatus of claim 1, wherein, to classify a first phrase in the set of phrases, the one or more processors are configured to:
identify a corresponding phrase associated with the first phrase in the at least one ground truth response;
determine a similarity between features of the corresponding phrase and features of the first phrase; and
determine a classification for the first phrase based on the similarity.

5. The apparatus of claim 4, wherein the one or more processors are configured to:
determine additional similarity between at least one of features of the corresponding phrase and not present in the first phrase or features of the first phrase and not in the corresponding phrase; and
determine the classification for the first phrase further based on the additional similarity.

6. The apparatus of claim 1, wherein the respective classifications include at least one of minimal overlapping features, majority overlapping features, or partial overlapping features.

7. The apparatus of claim 6, wherein each phrase in the first subset of phrases corresponds to the minimal overlapping features.

8. The apparatus of claim 6, wherein the one or more processors are configured to:
generate a respective score for each phrase in the second subset of phrases based on a quantity of overlapping features between features in the second subset of phrases and the at least one ground truth response.

9. The apparatus of claim 8, wherein each respective score and the at least one corresponding phrase are provided to a reinforcement learning feedback loop, wherein the reinforcement learning feedback loop is configured to train the first machine-learning model.

10. The apparatus of claim 1, wherein, to segment the natural language response and classify each phrase, the one or more processors are configured to provide a second query to a second machine-learning model different from the first machine-learning model, and wherein the second machine-learning model is configured to segment the natural language response into phrases, segment the at least one ground truth response into ground truth phrases, and compare the phrases and the ground truth phrases based on the second query.

11. The apparatus of claim 1, further comprising one or more microphones configured to capture the audio data.

12. A method comprising:
receiving a natural language response from a first machine-learning model, wherein the natural language response is responsive to a first natural language query;
segment the natural language response into a set of phrases;
classifying each phrase in the set of phrases based on at least one corresponding phrase in at least one ground truth response;
removing a first subset of phrases from the set of phrases based on respective classifications of the first subset of phrases, wherein the first subset of phrases are not verified in the at least one ground truth response; and
computing a metric associated with the first machine-learning model based on respective classifications of a second subset of phrases from the set of phrases, wherein the second subset of phrases are verified in the at least one ground truth response.

13. The method of claim 12, wherein the metric is associated with a difference in information in the natural language response and the at least one ground truth response.

14. The method of claim 12, wherein segmenting the natural language response comprises:
providing a second query to a second machine-learning model including the at least one ground truth response, wherein the second machine-learning model is different from the first machine-learning model.

15. The method of claim 12, further comprising classifying a first phrase in the set of phrases based on:
identifying a corresponding phrase associated with the first phrase in the at least one ground truth response;
determining a similarity between features of the corresponding phrase and features of the first phrase; and
determining a classification for the first phrase based on the similarity.

16. The method of claim 15, further comprising:
determining additional similarity between at least one of features of the corresponding phrase and not present in the first phrase or features of the first phrase and not in the corresponding phrase; and
determining the classification for the first phrase further based on the additional similarity.

17. The method of claim 12, wherein the respective classifications include at least one of minimal overlapping features, majority overlapping features, or partial overlapping features.

18. The method of claim 17, wherein each phrase in the first subset of phrases corresponds to the minimal overlapping features.

19. The method of claim 17, further comprising:
generating a respective score for each phrase in the second subset of phrases based on a quantity of overlapping features between features in the second subset of phrases and the at least one ground truth response, and wherein each respective score and the at least one corresponding phrase are provided to a reinforcement learning feedback loop, and wherein the reinforcement learning feedback loop is configured to train the first machine-learning model.

20. A non-transitory computer-readable medium comprising instructions stored thereon which, when executed by one or more processors, cause the one or more processors to:
receive a natural language response from a first machine-learning model, wherein the natural language response is responsive to a first natural language query;
segment the natural language response into a set of phrases;
classify each phrase in the set of phrases based on at least one corresponding phrase in at least one ground truth response;
remove a first subset of phrases from the set of phrases based on respective classifications of the first subset of phrases, wherein the first subset of phrases are not verified in the at least one ground truth response; and
compute a metric associated with the first machine-learning model based on respective classifications of a second subset of phrases from the set of phrases, wherein the second subset of phrases are verified in the at least one ground truth response.
